(19) United States
(12) Patent Application Publication
(10) Pub. No.: US 2025/0326624 A1
(43) Pub. Date: Oct. 23, 2025

(54) KEG COOLING UNIT

(71) Applicant: WILD GOOSE CANNING TECHNOLOGIES, LLC, Louisville, CO (US)

(72) Inventors: Carlo PETERMANN, Buffalo, NY (US); Daniel MOODY, Louisville, CO (US); Adam MCKIM, Louisville, CO (US); Corey PEMBERTON, Louisville, CO (US)

(73) Assignee: WILD GOOSE CANNING TECHNOLOGIES, LLC, Louisville, CO (US)

(21) Appl. No.: 19/182,869

(22) Filed: Apr. 18, 2025

Related U.S. Application Data
(60) Provisional application No. 63/636,515, filed on Apr. 19, 2024.
(60) Provisional application No. 63/636,656, filed on Apr. 19, 2024.
(60) Provisional application No. 63/648,825, filed on May 17, 2024.

(51) Int. Cl. B67D 1/08

(52) U.S. Cl. CPC B67D 1/0861; B67D 1/0891; B67D 2001/0822; B67D 2210/00139

(57) ABSTRACT

Portable keg cooling units, systems, and methods are described. In some examples, a portable keg cooling unit comprises a cabinet having a temperature-controlled inner compartment configured to house and cool a keg and its contents, a dispenser for dispensing beverage from the keg, and a chiller unit operable to cool beverage extracted from the keg, to ensure the beverage is at an optimal desired temperature when it reaches the dispenser to minimize undesirable foaming.

### CROSS-REFERENCE TO RELATED APPLICATIONS

This application claims priority to U.S. Provisional Application No. 63/636,515, filed Apr. 19, 2024, U.S. Provisional Application No. 63/636,656, filed Apr. 19, 2024, and U.S. Provisional Application No. 63/648,825, filed May 17, 2024, each of which is hereby incorporated by reference in its entirety.

### TECHNICAL FIELD

The subject matter of this application relates to units, systems, and methods for cooling and dispensing keg beverages such as beer and the like.

### BACKGROUND

Carbonated beverages, such as draft or draught beer, are commonly stored in relatively large-volume containers before being dispensed for personal consumption to smaller-volume containers, such as glasses, cups, pitchers, cans, or bottles. Beer, for example, may be stored under pressure in large volume metal kegs of various sizes (e.g., 50 L, ½ barrel (15.5 gall), ¼ barrel (7.75 gal), and ⅙ barrel (5.2 gal)). To dispense the beer from a keg, a coupler may be applied to the keg to permit external gas such as carbon dioxide or nitrogen to be introduced into the keg, and to permit pressurized beer to be withdrawn from the keg and conveyed to a dispensing tap. Conventional beer systems dispense at a flow rate between approximately 2.5 to 3.8 L/min (1 gal/min), and in some high-speed cases as high as 6 to 8 L/min (over 2 gal/min), depending on the consumer market and the type of beer.

Keg beer may be either pasteurized or non-pasteurized. Beer may be heat pasteurized during packaging by exposing the beer to heat sufficient to kill off any bacteria that would otherwise ferment and spoil the beer over time. Non-pasteurized beers, on the other hand, may be sterile filtered and chilled to a temperature sufficient to render any fermenting bacteria dormant. Pasteurized beers may be transported and stored at room temperature, whereas non-pasteurized beers are typically transported and stored under refrigeration (the “cold chain”) in order to preserve freshness and avoid spoiling. In the United States and Canada, keg beers are typically non-pasteurized and are transported and stored at temperatures between approximately 34 and 38° F. Keg beers from the rest of the world are typically pasteurized, and may be stored at room temperature (e.g., about 70° F.), although they may also be stored at lower temperatures along with non-pasteurized product.

One of the issues with dispensing keg beverages is the creation of unwanted foam during the dispensing process. This foam is created by release of solubilized gas from the liquid, referred to as “desaturation.” Excessive foaming generates waste of the beverage. For example, it is estimated that as much as approximately 25% of beer is wasted when dispensed from a keg using conventional systems and methods. Various conventional systems and methods have been proposed for increasing keg yield by reducing waste, but each may suffer from one or more limitations. Examples of conventional systems and limitations are described in the background section of U.S. Pat. No. 10,662,053. U.S. Pat. No. 10,662,053 goes on to describe alternative fluid dispensing systems and methods for reducing foaming. These systems and methods may be used in combination with the units, systems, and methods described herein. U.S. Pat. No. 10,662,053 is incorporated by reference in its entirety.

A major contributor to keg beer waste is poor keg management, for example when kegs are not stored, or the contained beer not dispensed, at proper temperature. In general, higher temperatures tend to result in more foam. To drop a keg's temperature by just a few degrees takes hours, which may not be available in many circumstances. Instead of waiting for a keg to arrive at the optimal temperature, bartenders often dispense keg beer at sub-optimal temperatures resulting in heavy desaturation (i.e., heavy foam) and waste. Additional refrigeration units may be provided, such as an ice-bank refrigeration unit, to assist in cooling the beer line between the refrigerated storage unit and the dispenser. While such devices may be generally helpful in limiting temperature increase in the beer line, these and other retrofit solutions have numerous limitations, including increased cost, complexity, and power consumption associated with using multiple dedicated refrigeration units and their associated components (compressors, condensers, evaporators, and expanders), among other things. In addition, these prior art solutions present substantial space constraints, as they require additional space for multiple refrigeration units, as well as for bulky insulated trunk/python lines between the ice-bank chiller and dispenser.

There is an unmet need in the field for units, systems, and methods for cooling and dispensing keg beverages. Examples below satisfy this unmet need in various ways, including the ability to reduce undesirable foam using kegs at temperatures greater than optimal (e.g., between approximately 40° F. and 42° F. or greater), and to allow the temperature of stored beer to be decreased quickly and efficiently, for example by 5-8 degrees Fahrenheit or more in seconds depending on the dispense frequency.

The subject matter described and illustrated in U.S. Provisional Application Nos. 63/636,515 and 63/648,825 is suitable for combination and use with the invention(s) described in this application and such combinations are contemplated by the inventors as within the scope of their invention.

### BRIEF DESCRIPTION OF THE DRAWINGS

FIG. 1A is a perspective view of a keg cooling unit as described herein.

FIG. 1B is an alternative partial perspective view of the keg cooling unit of FIG. 1A.

FIG. 2 is a schematic illustrating various components of an example of a keg cooling unit.

FIG. 3 is a schematic illustrating various components of an example of a keg cooling unit.

FIG. 4A is a schematic illustrating a portion of a keg cooling unit including an example of an electronic fob.

FIGS. 4B and 4C are schematics illustrating the electronic fob shown in FIG. 4A in an “empty” keg state and a “non-empty” keg state, respectively.

### DETAILED DESCRIPTION

For the purpose of promoting an understanding of the principles of the inventions, reference will now be made to various examples illustrated and described in the drawings and throughout this application, including in the specification and claims as well as in the subject matter incorporated by reference. These examples are intended to be non-exhaustive, and no limitation of the scope of the inventions described and claimed herein is intended. Additional examples within the scope of these inventions are contemplated and would be apparent to a person of ordinary skill in the art, including alterations and modifications to specific examples described herein, and further applications of the principles of the inventions. For example, while the examples below refer to beer, the scope of the inventions is not so limited and includes other suitable beverages.

Unless otherwise indicated, all numbers used herein to express quantities, dimensions, degrees, and the like, should be understood as being modified in all instances by the term “about,” and that term would be understood to encompass standard mechanical tolerances and variations as known in the art. Unless otherwise indicated, each numerical value in this disclosure is intended to encompass both the recited value and functionally equivalent values/ranges surrounding that value.

The use of the singular includes the plural unless specifically stated otherwise and the use of the terms “and” and “or” means “and/or” unless otherwise indicated. The use of the terms “comprising,” “including,” “having,” “regarding,” and the like are non-exclusive and non-limiting.

The term “keg” is used broadly to refer to a pressurized vessel used to store and dispense a beverage in bulk, without limitation as to size, dimension, composition, material, or stored and dispensed beverage. Kegs may be made of any material suitable for the particular intended use, including for example stainless steel, aluminum, glass, plastic, and wood. Examples of keg beverages include, but are not limited to, beer, wine, cider, soft drinks, coffee, tea, kombucha, and the like.

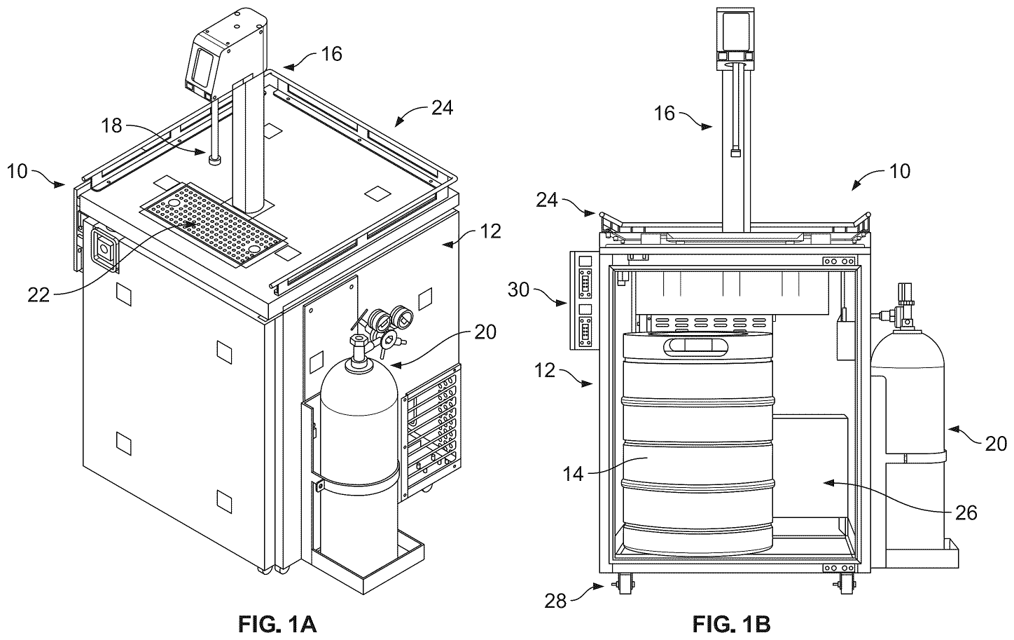

FIGS. 1A and 1B illustrate alternative views of a keg cooling unit 10. The keg cooling unit 10 comprises a cabinet 12 configured to house a keg 14 and to cool a keg beverage therein, and a tower 16 with a beverage dispenser for dispensing via nozzle 18 cooled beverage extracted from the keg 14. U.S. Pat. No. 10,662,053 and U.S. Provisional Application Nos. 63/636,515 and 63/648,825 (incorporated by reference herein) each disclose examples of fluid dispensing systems and nozzles that may be suitable in examples according to this disclosure.

Although one keg 14 is illustrated in FIG. 1B, a cabinet 12 may be configured to house multiple kegs at the same time. In these examples, the tower 16 may be configured to distribute and dispense beverages from multiple kegs at the same time, for example using separate beverage lines and nozzles for each keg. One or more gas cylinders 20 (one shown in the figures) may be provided, each with a gas (e.g., carbon dioxide or nitrogen) for pressurizing the keg(s). As illustrated, the cabinet 12 may comprise a fixture for releasably mounting and holding the gas cylinder 20 on the cabinet 12.

As shown in FIG. 1A, the outer top surface of the cabinet 12 comprises a generally horizontal planar table surface. The tower 16 includes a main body portion extending vertically from the outer top surface of the cabinet 12, and a nozzle portion comprising the nozzle 18 extending generally towards the top surface. A drip tray 22 is disposed beneath the nozzle 18, to collect drips and spills during dispensing of the keg beverage. The unit 10 may also include a railing 24 disposed about a periphery on the outer top surface of the cabinet 12 and extending vertically above the outer top surface, to permit items such as pitchers and glasses to be placed and/or stored on the outer top surface without falling off.

As shown in FIG. 1B, the keg 14 is housed within an inner compartment 26 of the cabinet 12. The inner compartment 26 is preferably temperature controlled. Thus, a refrigeration unit and controls (not shown) are provided to cool and maintain the inner compartment 26 at any desired temperature range. In some examples, the keg cooling unit 10 may be operable to maintain the inner compartment 26 at or around room temperature. In other examples, the inner compartment 26 may be controlled at a temperature above or below room temperature. In some examples, the inner compartment 26 may be controlled at a temperature between 3° and 78° F., between 32 and 78° F., or between 34 and 78° F. In some examples, the inner compartment may be controlled at a temperature between 32 and 34° F., between 32 and 38° F., or between 32 and 42° F. In some examples, the inner compartment 26 may be controlled at a temperature between 34 and 38° F., or between 34 and 42° F. In some examples, the inner compartment 26 may be controlled at a temperature between 4° and 42° F. In some examples, the inner compartment 26 may be controlled at a temperature between 68 and 74° F.

The keg cooling unit 10 may comprise additional components for cooling the keg beverage after it has been extracted from the keg, while it is being conveyed to and through the nozzle 18 for dispensing. This permits the temperature of the keg beverage to be maintained or further decreased as desired, until the beverage is actually dispensed through the nozzle. In some examples, the cooling components may be designed and utilized to decrease the temperature of the keg beverage by 1 or more degrees Fahrenheit, by 2 or more degrees Fahrenheit, or by 5 or more degrees Fahrenheit, between extraction from the keg and dispensing from the nozzle. In some preferred examples, the cooling components may be designed and utilized to decrease the temperature of the keg beverage by approximately 1 to 2 degrees Fahrenheit or greater, or by 5 to 8 degrees Fahrenheit or greater. In these examples, the keg(s) may be housed within the temperature-controlled cabinet 12 at a temperature of 40 to 42° F., and dispensed for consumption at a lower serving temperature of 34 to 38° F., as desired.

The keg cooling unit 10 illustrated in FIGS. 1A and 1B is preferably portable (capable of being ported). As such, portable keg cooling unit 10 is designed and configured so that the entire unit, including storage and dispensing components, may be moved and transported as a single unit if desired (or not ported, if not desired). As shown in FIG. 1B, the unit 10 may optionally comprise a plurality of wheels 28, each coupled to the cabinet 12. In the example shown, the wheels 28 are coupled to the bottom of the cabinet 12, although other configurations and designs within the knowledge and routine skill of a person of ordinary skill in the art are contemplated. A distribution unit 30, for example, may be provided for connecting components of the keg cooling unit 10 to electrical service, computers, web servers, peripherals, and the like.

Various sizes of units are contemplated. The following chart illustrates several non-limiting examples of approximate sizings for a portable keg cooling unit cabinet for storing half barrel size kegs.

| # Half | | | | | |
|---|---|---|---|---|---|
| Barrel | External | Internal | Length | Width | Height |
| Kegs | (ft³) | (ft³) | (in.) | (In.) | (In.) |
| 1 | 17 | 6.4 | 28 | 28 | 38 |
| 2 | 31 | 14 | 50 | 28 | 38 |
| 3 | 42 | 22 | 68 | 28 | 38 |
| 4 | 58 | 31 | 94 | 28 | 38 |

Other sizings are contemplated, including cabinets of varying widths and heights, and cabinets sized to receive different sized keg containers or for receiving multiple keg containers of varying sizes, among other things.

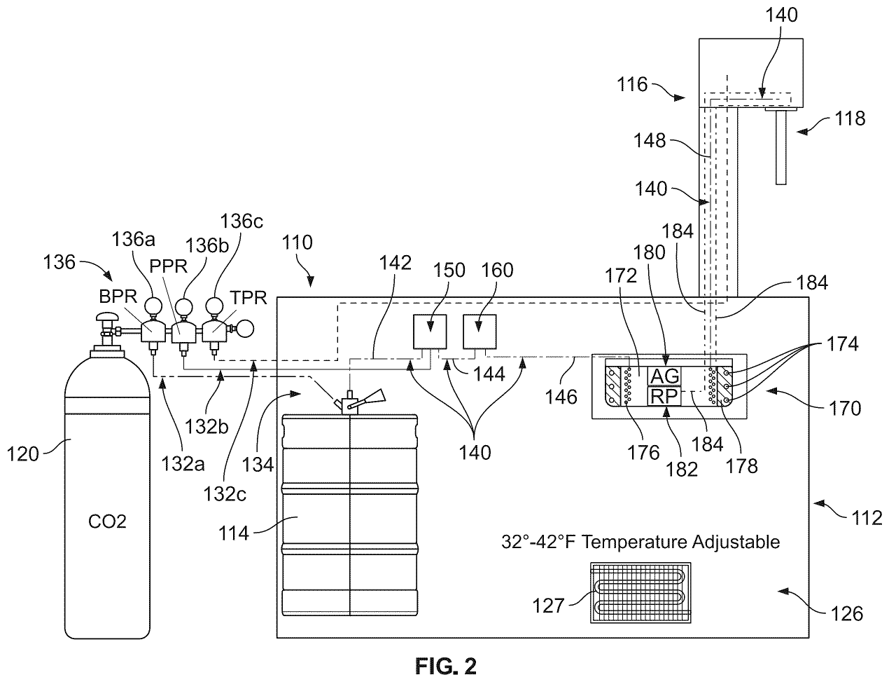

FIG. 2 is a schematic illustrating a keg cooling unit 110. The keg cooling unit 110 may be portable as described above. The unit 110 comprises a cabinet 112 for housing a keg 114, and a tower 116 for distributing and dispensing beverage extracted from the keg 114. In addition, the unit 110 comprises a refrigeration unit comprising a compressor (not shown), condenser (not shown), evaporator 127, 174, and expander (e.g., thermostatic expansion valve or capillary tube) (not shown). Keg 114 is disposed within inner compartment 126 of cabinet 112. Inner compartment 112 may be refrigerated and temperature controlled as described above, for example at a temperature between 32 and 42° F. In one example, the refrigeration unit may comprise an evaporator unit 127 in thermal communication with the inner compartment 112 to cool the compartment. Gas cylinder 120 may be disposed inside or outside the cabinet 112 (FIG. 2 illustrates gas cylinder 120 outside the cabinet 112), in fluid communication with keg 114 via gas tube 132 and coupler 134. Gas cylinder 120 contains carbon dioxide gas in this example, but in other examples could contain nitrogen gas. Alternatively, multiple gas cylinders could be provided in fluid communication with keg 114 including both carbon dioxide and nitrogen gas.

Pressure regulator 136 regulates the flow of gas from the cylinder 120 to various components. Regulator 136 comprises a beer pressure regulator (BPR) 136a for regulating flow of gas to the keg 114. Gas tube 132a is coupled at one end to the gas cylinder 120 via BPR 136a, and at the other end to the keg 114 via coupler 134. Pressure regulator 136 further comprises a pump pressure regulator (PPR) 136b for regulating flow of gas with beer pump 140 via gas tube 132b, and a tower pressure regulator (TPR) 136c for regulating flow of gas with the tower 116 via gas tube 132c. In some examples, multiple beer pressure regulators and beer pumps may be provided, for example in systems comprising multiple dispensers for dispensing beverages from multiple kegs with different beverages.

Keg cooling unit 110 comprises a beverage line 140 for conveying keg beverage from keg 114 to the tower 116 and nozzle 118. Although one beverage line 140 is shown, examples with multiple beverage lines are contemplated and within the scope of this description. As illustrated in FIG. 2, beverage line 140 comprises a series of fluidly communicating tubes and components disposed between keg 114 at one end, and nozzle 118 at the other end. In the example illustrated in FIG. 2, beverage line comprises tube portions 142, 144, 146, 148; pump 150; fob (foam on beer) unit 160; and cooler 170.

Beverage tube 142 conveys beverage from the keg 114 to beverage pump 150. Beverage tube 142 is coupled at an upstream end to keg 114 via coupler 134, and at a downstream end to beverage pump 150. Beverage pump 150 is configured to increase the inline beverage pressure to overcome any subsequent pressure drop caused by tubes and components downstream in the beverage line 140, and to achieve desired dispense rates. Beverage pump 150 has a fluid inlet coupled to a downstream end of beverage tube 142, and a fluid outlet coupled to an upstream end of beverage tube 144.

Beverage tube 144 conveys beverage from beverage pump 150 to fob (foam on beer) unit 160. Fob units are generally known in the art, and are used to prevent beer from flowing for example when a keg runs out or when the beer line is compromised. Fob unit 160 has a fluid inlet coupled to a downstream end of beverage tube 144, and a fluid outlet coupled to an upstream end of beverage tube 146. Fob unit 160 may be configured to sense when keg beverage containing undesirable foam enters the unit 160, for example when the keg 114 is running out or when the beverage line 140 upstream of the fob unit has become compromised. When this happens, a valve shuts off the flow of beverage through the unit 160, keeping the remainder of the system pressurized and preventing undesirable foam from entering beverage tube 144 and traveling through the beverage line 140 to the nozzle 118. Fob unit 160 is particularly desirable to maintain pressurization in the beverage line 140 during keg changes, where undesirable foam could otherwise contaminate the line resulting in unnecessary waste.

In preferred examples, fob unit 160 is an electronic fob, although entirely mechanical fobs are also contemplated. The fob unit 160 provides a gas bleed off to purge gas from the line before the beverage leaves the unit 160. This allows for a smooth transition between empty and new kegs, while minimizing or preventing desaturated gas from continuing through the beverage line 140 and reaching the dispense nozzle in the nozzle. Any fob unit generally known to a person of ordinary skill in the art may be used in a keg cooling unit according to this application. U.S. Pat. No. 10,662,053 (incorporated by reference herein) discloses examples of foam on beer detectors that may be suitable in examples according to this disclosure.

Beverage tube 146 conveys beverage from fob unit 160 to cooler 170. Beverage tube 146 is coupled at an upstream end to fob unit 160, and at a downstream end to cooler 170. Cooler 170 has a fluid inlet coupled to a downstream end of beverage tube 146, and a fluid outlet coupled to an upstream end of beverage tube 148. Cooler 170 is configured to decrease the temperature of the beverage to (or maintain it at) a desirable dispensing temperature. In one example, cooler 170 may comprise a coil cooling system immersed in a water or glycol bath.

As illustrated in FIG. 2, cooler 170 may comprise an ice bank cooler comprising a coolant tank 172, evaporator coil 174, a beverage coil 176, and an agitator 180 (e.g., a stirrer). The coolant tank 172 comprises a liquid coolant. Evaporator coil 174 passes through coolant tank 172 in thermal communication with the coolant. In some examples, the coolant may be water. In other examples, the coolant may be a mixture of water and glycol. Water/glycol mixtures are particularly suitable in higher risk foaming situations, for example with highly carbonated beverages, or in applications requiring long continuous pour (e.g., pitcher dispensing applications). In these examples, the coolant may comprise a glycol mix with a freezing point preferably no lower than 28° F. In use, the evaporator coil 174 chills the coolant, which causes an ice bank 178 to form around the coil 174. The ice bank 178 comprises a portion of the total volume of coolant in the coolant tank 172, with the remainder comprising liquid coolant. In some examples, the ice bank 178 may comprise up to ⅓ of the total volume of coolant in the coolant tank 172 (the remainder comprising liquid coolant).

In FIG. 2, cooler 170 comprises a beverage coil 176. The beverage coil 176 has an inlet in fluid communication with a downstream end of beverage tube 146, and an outlet in fluid outlet with an upstream end of beverage tube 148. Beverage coil 176 passes through coolant tank 172 in thermal communication with the coolant. In use, the ice bank 178 maintains the coolant at a temperature lower than the temperature of the beverage entering the cooler 170. Accordingly, thermal contact between the beverage coil 176 and coolant will cause the temperature of the beverage within the coil 176 to decrease. Agitator 180 agitates the liquid coolant in the tank 172, to ensure optimal heat exchange between the beverage conveyed in coil 176 and the ice bank 178.

Chilled beverage exits the coolant tank 172 and is conveyed through the tower 116 to nozzle 118 via beverage tube 148. As shown in FIG. 2, keg cooling unit 110 further comprises a recirculation pump 182 and refrigerated recirculation line 184. The refrigerated recirculation line 184 recirculates chilled coolant from the coolant tank 172 up through the tower 116 to the nozzle 118 (“ascending” recirculation line 184), and then returns through the tower 116 back to the tank 172 (“descending” recirculation line 184). At least a portion of the refrigerated recirculation line 184 is in thermal contact with the beverage line 140. In some embodiments, a substantial portion of the recirculation line 184 is continuously in contact with beverage tube 148. In some embodiments, a portion of the ascending recirculation line 184 is in thermal contact with beverage tube 148, and preferably a substantial portion is in continuous thermal contact with the beverage tube 148 along that portion. In these embodiments, a portion of the descending recirculation line 184 may also be in thermal contact with beverage tube 148, and preferably a substantial portion is in continuous thermal contact with the beverage tube 148 along that portion. A substantial portion may comprise thermal contact sufficient to ensure beverage exiting coolant tank 172 remains chilled as it is conveyed into and through the tower 116 to nozzle 118. Depending on the system, a substantial portion may include at least 50%, at least 60%, at least 80%, at least 90%, or at least 95%.

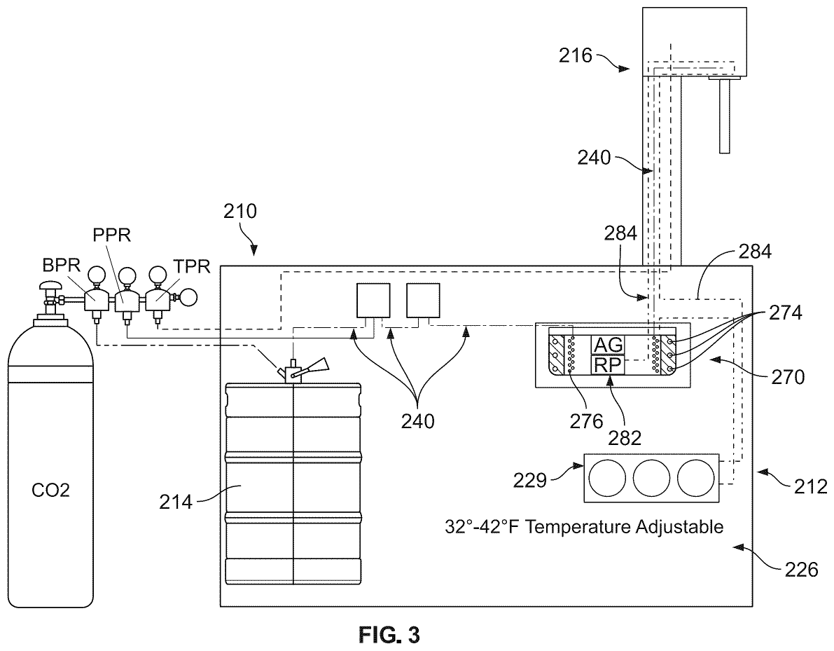

FIG. 3 is a schematic illustrating a keg cooling unit 210. Keg cooling unit 210 is preferably portable as described above, and may comprise one or more of the features described above, such as wheels, drip trays, railings, fob units, beverage pumps, couplers, coolers, and pressure regulators, among other things. As illustrated in FIG. 3, keg cooling unit 210 comprises a cabinet 212 for housing one or more kegs 214, and a tower 216 for distributing and dispensing beverage extracted from the kegs 214. The unit 210 comprises a refrigeration unit comprising a compressor (not shown), condenser (not shown), evaporator 274, expander (not shown), and radiator unit 229. Keg 214 is disposed within inner compartment 226 of cabinet 212. Inner compartment 212 may be refrigerated and temperature controlled as described above. Keg cooling unit 210 comprises a beverage line 240 for conveying keg beverage from the keg 214 to the dispenser. In addition, keg cooling unit 210 comprises a cooler 270, such as an ice bank cooler with a coolant recirculation pump 282 and refrigerated recirculation line 284, for cooling the keg beverage as it is conveyed through the beverage line 240 to the dispenser.

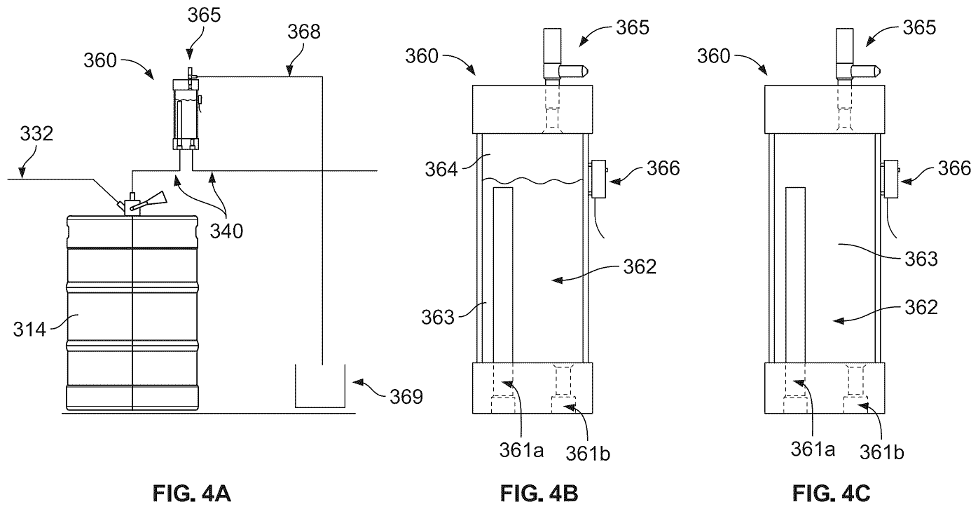

In contrast with the keg cooling unit 110 described above, which may have an evaporator unit 127 for cooling inner compartment 112, keg cooling unit 210 comprises a radiator unit 229 in fluid communication with refrigerated recirculation line 284. Radiator unit 229 may comprise a thermostat and radiator fan (not shown) for blowing cool air into the inner compartment 212. As shown in FIG. 4, radiator unit 229 may be fluidly disposed within the descending portion of the recirculation line 284 (the portion returning from the tower towards the cooler tank), before the coolant returns to the cooler tank. Thus, the same chilled coolant (e.g., water or water/glycol mix) that cools the beverage line 240 may be used to cool inner compartment 212. This results in a simpler, more efficient and cost-effective refrigeration unit. The temperature of the inner compartment 212 may be controlled by enabling/disabling the radiator fan via the thermostat (not shown).

FIGS. 4A-4C are schematics illustrating an electronic fob unit 360. The purpose of the fob unit is to prevent gas from an empty keg from reaching the dispense point of the beverage (e.g., a tower/nozzle). The fob unit is preferably installed in a beverage line near the keg 314, and is configured to detect an empty keg. Once an empty keg is detected, the fob unit 360 sends a signal to a control unit (not shown) to immediately shut off the dispensing function before undesirable gas passes through the beverage line to the dispense point. Fob unit 360 may be used in a keg cooling unit as described above, or in any other suitable keg dispensing application in accordance with the knowledge and skill of a person of ordinary skill in the art.

In FIG. 4A, fob unit 360 is illustrated in combination with a keg 314. A gas line 332 couples keg 314 with a gas cylinder (not show) comprising a gas (e.g., carbon dioxide or nitrogen) for pressurizing keg 314. A beverage line 340 conveys keg beverage from keg 314 to a tower/nozzle (not shown), for example a tower and nozzle as described in U.S. Provisional Application Nos. 63/636,515 and 63/648,825 (incorporated by reference). The fob unit 360 is installed in beverage line 340 near the keg 314, between the keg 314 and the tower/nozzle (not shown). In operation, beverage from the keg 314 passes into and through the fob unit 360 before it travels to the tower/nozzle. The fob unit 360 is coupled to a gas purge line 368 via gas purge valve 365.

FIGS. 4B and 4C illustrate electronic fob unit 360 in an “empty” keg state and “non empty” keg state, respectively. The fob unit 360 comprises a container or vessel having an internal volume 362. The fob unit 360 comprises a beverage inlet line 361a and a beverage outlet line 361b. During operation, beverage from keg 314 enters the internal volume 362 of the fob unit 360 via beverage line 340 through beverage inlet line 361a, and exits the internal volume 362 of the fob unit 360 via beverage outlet line 361b. Beverage inlet line 361a is configured so that beverage enters the internal volume 362 generally towards the top of the internal volume, whereas beverage outlet line 361b is configured so that beverage exits the internal volume generally towards the bottom of the internal volume.

During operation when the keg 314 is at least partially filled, liquid beverage 363 occupies the internal volume 362 of the fob unit 360 as shown in FIG. 4C. As soon as the keg 314 empties, gas 364 from the empty keg travels through the beverage line 340 to the fob unit 360, and enters the internal volume 362 of the vessel via beverage inlet line 361a. As illustrated in FIG. 4B, this causes the liquid 363 inside the container to drop in level as gas 364 from the keg 314 enters the internal volume 362. The fob unit 360 comprises a sensor configured to sense when the liquid level drops to a predetermined level, and is configured to send a signal to a control unit (for example in a dispense tower) to stop dispensing immediately when that happens.

As shown in FIGS. 4B and 4C, the sensor may comprise a liquid level sensor 366 coupled to the fob unit 360 outside of the internal volume 362 (for example on an outside surface of the container or vessel). Examples of suitable liquid level sensors include non-contact liquid level sensors using inductive capacitance of water to detect the presence of liquid in a region adjacent the sensor. Such sensors may be configured to detect liquid through a detection signal through the container or vessel of the electronic fob unit 360, without direct contact with the liquid. Suitable sensors include for example Y26 non-contact liquid level sensors from XKC (Shenzhen XingKeChuang) Technology.

Liquid level sensor 366 is coupled to the fob unit 360 and positioned to sense when the liquid level drops to a predetermined level, thereby indicating the presence of gas 364 in the internal volume 362. As soon as the liquid level reaches a predetermined level, an “EMPTY KEG” signal may be sent to the control unit (not shown) to stop dispensing, thereby preventing gas (or liquid beverage) from exiting the fob unit 360 until further action is taken to replace the empty keg. Once the empty keg is replaced with a filled keg, the gas in the fob unit 360 may then be purged from the internal volume 362 by opening purge valve 365, which is in pneumatic communication with the internal volume. Valve 365 may be coupled to purge line 368 to drain into a container 369 such as a bucket, or the like. As gas is purged, liquid from the keg may enter the internal volume 362 causing the liquid level to rise and fill the internal volume 362. The liquid level sensor 366 may be configured to sense when the liquid level rises to a predetermined level indicating gas has been purged from the fob unit 360. A “New Keg” signal may then be sent to the control unit (not shown) to permit dispensing to continue.

The following are example claims:

1. A portable keg cooling unit comprising: a cabinet having a temperature-controlled inner compartment configured to house a keg, and to maintain a beverage contained in the keg at a first predetermined temperature; a dispenser operable to dispense beverage extracted from the keg; and a chiller unit operable to cool beverage after it is extracted from the keg to a second predetermined temperature at the dispenser.

2. The portable unit of claim 1, where the second predetermined temperature is less than the first predetermined temperature.

3. The portable unit of claim 1, where the second predetermined temperature is at least 1-2 degrees Fahrenheit less than the first predetermined temperature.

4. The portable unit of claim 1, where the temperature-controlled inner compartment is refrigerated.

5. The portable unit of claim 1, where the first predetermined temperature is 32 to 42° F.

6. The portable unit of claim 1, where the first predetermined temperature is greater than 40° F.

7. The portable unit of claim 1, further comprising a beverage line comprising an upstream end in fluid communication with a downstream end to form a beverage conduit, where the temperature-controlled inner compartment comprises the upstream end of the beverage line, the dispenser comprises the downstream end of the beverage line, and the chiller unit is in thermal communication with the beverage conduit.

8. The portable unit of claim 7, where the chiller unit comprises a liquid coolant in thermal communication with the beverage line.

9. The portable unit of claim 8, where the coolant comprises water.

10. The portable unit of claim 8, where the coolant comprises glycol.

11. The portable unit of claim 8, where the coolant has a freezing point of at least 28° F.

12. The portable unit of claim 7, where the chiller unit comprises a coolant conduit and a coolant pump operable to circulate coolant through the coolant conduit, where at least a portion of the coolant conduit is in thermal communication with a downstream portion of the beverage line.

13. The portable unit of claim 12, where at least a portion of the coolant conduit is in continuous thermal communication with a downstream portion of the beverage line.

14. The portable unit of claim 1, where the chiller unit comprises an ice bank cooler.

15. The portable unit of claim 7, where the chiller unit is in fluid communication with the beverage conduit.

16. The portable unit of claim 7, where the chiller unit comprises a portion of the beverage conduit.

17. The portable unit of claim 1, further comprising a keg containing a beverage.

18. The portable unit of claim 7, further comprising a keg containing a beverage.

19. The portable unit of claim 18, comprising a coupler configured to fluidly couple the keg to the upstream end of the beverage line.

20. The portable unit of claim 18, where the keg is fluidly coupled to the upstream end of the beverage line.

21. The portable unit of claim 18, further comprising a gas cylinder comprising at least one of carbon dioxide and nitrogen, and a coupler configured to fluidly couple the gas cylinder to the keg to pressurize the keg.

22. The portable unit of claim 7, where the chiller unit is in thermal communication with a downstream portion of the beverage line.

23. The portable unit of claim 7, where the chiller unit is in thermal communication with the downstream end of the beverage line.

24. The portable unit of claim 7, where the chiller unit is in continuous thermal communication with a downstream portion of the beverage line.

25. The portable unit of claim 7, further comprising a beverage pump in fluid communication with the beverage line and operable to increase an inline beverage pressure within the beverage conduit.

26. The portable unit of claim 25, where the beverage pump is fluidly disposed between upstream end of the beverage line and the chilling unit.

27. The portable unit of claim 7, further comprising an electronic fob in fluid communication with the beverage line.

28. The portable unit of claim 27, where the electronic fob is fluidly disposed between an upstream end of the beverage line and the chilling unit.

29. The portable unit of claim 28, where the electronic fob comprises a vessel having an internal volume in fluid communication with the beverage line, and a liquid level sensor configured to sense a level of a liquid within the internal volume.

30. The portable unit of claim 29, where the liquid level sensor is coupled to the electronic fob outside of the internal volume.

31. The portable unit of claim 29, where the liquid level sensor is a non-contact liquid level sensor configured to sense a level of a liquid without direct contact with the liquid.

32. The portable unit of claim 29, where the electronic fob is operable to prevent dispensing of beverage from the keg when the liquid level sensor senses a predetermined level of the liquid within the internal volume.

33. The portable unit of claim 1, where the chiller unit is operable to cool the temperature-controlled inner compartment.

34. The portable unit of claim 1, comprising an evaporator unit operable to cool the temperature-controlled inner compartment.

35. The portable unit of claim 1, comprising a radiator unit operable to cool the temperature-controlled inner compartment.

36. The portable unit of claim 1, comprising a single refrigeration unit operable to cool both the temperature-controlled inner compartment and the chiller unit.

37. The portable unit of claim 36, where the single refrigeration unit comprises an evaporator unit operable to cool the chiller unit.

38. The portable unit of claim 36, where the single refrigeration unit comprises a second evaporator unit operable to cool the temperature-controlled inner compartment.

39. The portable unit of claim 36, where the single refrigeration unit comprises a radiator unit operable to cool the temperature-controlled inner compartment.

40. The portable unit of claim 1, comprising a plurality of wheels coupled to the cabinet.

41. A portable keg cooling unit comprising one or more of the following: (a) a cabinet having a temperature-controlled inner compartment configured to house a keg, and to maintain a beverage contained in the keg at a first predetermined temperature; (b) a dispenser operable to dispense beverage extracted from the keg; (c) a chiller unit operable to cool beverage extracted from the keg to a second predetermined temperature at the dispenser; (d) the second predetermined temperature is less than the first predetermined temperature; (e) the second predetermined temperature is at least 1-2 degrees Fahrenheit less than the first predetermined temperature; (f) the second predetermined temperature is 5-8 degrees Fahrenheit less than the first predetermined temperature; (g) the temperature-controlled inner compartment is refrigerated; (h) the first predetermined temperature is 32 to 42° F.; (i) the first predetermined temperature is greater than 40° F.; (j) further comprising a beverage line comprising an upstream end in fluid communication with a downstream end to form a beverage conduit, where the temperature-controlled inner compartment comprises the upstream end of the beverage line, the dispenser comprises the downstream end of the beverage line, and the chiller unit is in thermal communication with the beverage conduit; (k) the chiller unit comprises a liquid coolant in thermal communication with the beverage line; (l) the coolant comprises water; (m) the coolant comprises glycol; (n) the coolant has a freezing point of at least 28° F.; (o) the chiller unit comprises a coolant conduit and a coolant pump operable to circulate coolant through the coolant conduit, at least a portion of the coolant conduit is in thermal communication with a downstream portion of the beverage line; (p) the chiller unit comprises an ice bank cooler; (q) the chiller unit is in fluid communication with the beverage conduit; (r) the chiller unit comprises a portion of the beverage conduit; (s) a keg containing a beverage; (t) a coupler configured to fluidly couple the keg to the upstream end of the beverage line; (u) the keg is fluidly coupled to the upstream end of the beverage line; (v) a gas cylinder comprising at least one of carbon dioxide and nitrogen, and a coupler configured to fluidly couple the gas cylinder to the keg to pressurize the keg; (w) the chiller unit is in thermal communication with a downstream portion of the beverage line; (x) the chiller unit is in thermal communication with the downstream end of the beverage line; (y) the chiller unit is in continuous thermal communication with a downstream portion of the beverage line; (z) a beverage pump in fluid communication with the beverage line and operable to increase the inline beverage pressure within the beverage conduit; (aa) the beverage pump is fluidly disposed between upstream end of the beverage line and the chilling unit; (bb) an electronic fob in fluid communication with the beverage line; (cc) the electronic fob is fluidly disposed between upstream end of the beverage line and the chilling unit; (dd) the chiller unit is operable to cool the temperature-controlled inner compartment; (ee) an evaporator unit operable to cool the temperature-controlled inner compartment; (ff) a radiator unit operable to cool the temperature-controlled inner compartment; (gg) a single refrigeration unit operable to cool both the temperature-controlled inner compartment and the chiller unit; (hh) the single refrigeration unit comprises an evaporator unit operable to cool the chiller unit; (ii) the single refrigeration unit comprises an evaporator unit operable to cool the temperature-controlled inner compartment; (jj) the single refrigeration unit comprises a radiator unit operable to cool the temperature-controlled inner compartment; (kk) a plurality of wheels coupled to the cabinet; (II) the electronic fob comprises a vessel having an internal volume in fluid communication with the beverage line, and a liquid level sensor configured to sense a level of a liquid within the internal volume; (mm) the liquid level sensor is coupled to the electronic fob outside of the internal volume; (nn) the liquid level sensor is a non-contact liquid level sensor configured to sense a level of a liquid without direct contact with the liquid; and (oo) the electronic fob is operable to prevent dispensing of beverage from the keg when the liquid level sensor senses a predetermined level of the liquid within the internal volume.

Although the invention has been described and illustrated with reference to specific illustrative examples thereof, it is not intended that the invention be limited to those examples. Those skilled in the art will recognize that variations and modifications can be made without departing from the true scope and spirit of the inventions as defined by the claims that follow. It is therefore intended to include within the inventions all such variations and modifications as fall within the scope of the appended claims and equivalents thereof.

We claim:

1. A portable keg cooling unit comprising:
a cabinet having a temperature-controlled inner compartment configured to house a keg, and to maintain a beverage contained in the keg at a first predetermined temperature;
a dispenser operable to dispense beverage extracted from the keg; and
a chiller unit operable to cool beverage after it is extracted from the keg to a second predetermined temperature at the dispenser.

2. The portable unit of claim 1, where the second predetermined temperature is less than the first predetermined temperature.

3. The portable unit of claim 1, where the second predetermined temperature is at least 1-2 degrees Fahrenheit less than the first predetermined temperature.

4. The portable unit of claim 1, where the temperature-controlled inner compartment is refrigerated.

5. The portable unit of claim 1, where the first predetermined temperature is 32 to 42° F.

6. The portable unit of claim 1, where the first predetermined temperature is greater than 40° F.

7. The portable unit of claim 1, further comprising a beverage line comprising an upstream end in fluid communication with a downstream end to form a beverage conduit, where the temperature-controlled inner compartment comprises the upstream end of the beverage line, the dispenser comprises the downstream end of the beverage line, and the chiller unit is in thermal communication with the beverage conduit.

8. The portable unit of claim 7, where the chiller unit comprises a liquid coolant in thermal communication with the beverage line.

9. The portable unit of claim 8, where the coolant comprises water.

10. The portable unit of claim 8, where the coolant comprises glycol.

11. The portable unit of claim 8, where the coolant has a freezing point of at least 28° F.

12. The portable unit of claim 7, where the chiller unit comprises a coolant conduit and a coolant pump operable to circulate coolant through the coolant conduit, where at least a portion of the coolant conduit is in thermal communication with a downstream portion of the beverage line.

13. The portable unit of claim 12 where at least a portion of the coolant conduit is in continuous thermal communication with a downstream portion of the beverage line.

14. The portable unit of claim 1, where the chiller unit comprises an ice bank cooler.

15. The portable unit of claim 7, where the chiller unit is in fluid communication with the beverage conduit.

16. The portable unit of claim 7, where the chiller unit comprises a portion of the beverage conduit.

17. The portable unit of claim 1, further comprising a keg containing a beverage.

18. The portable unit of claim 7, further comprising a keg containing a beverage.

19. The portable unit of claim 18, comprising a coupler configured to fluidly couple the keg to the upstream end of the beverage line.

20. The portable unit of claim 18, where the keg is fluidly coupled to the upstream end of the beverage line.

21. The portable unit of claim 18, further comprising a gas cylinder comprising at least one of carbon dioxide and nitrogen, and a coupler configured to fluidly couple the gas cylinder to the keg to pressurize the keg.

22. The portable unit of claim 7, where the chiller unit is in thermal communication with a downstream portion of the beverage line.

23. The portable unit of claim 7, where the chiller unit is in thermal communication with the downstream end of the beverage line.

24. The portable unit of claim 7, where the chiller unit is in continuous thermal communication with a downstream portion of the beverage line.

25. The portable unit of claim 7, further comprising a beverage pump in fluid communication with the beverage line and operable to increase an inline beverage pressure within the beverage conduit.

26. The portable unit of claim 25, where the beverage pump is fluidly disposed between upstream end of the beverage line and the chilling unit.

27. The portable unit of claim 7, further comprising an electronic fob in fluid communication with the beverage line.

28. The portable unit of claim 27, where the electronic fob is fluidly disposed between an upstream end of the beverage line and the chilling unit.

29. The portable unit of claim 28, where the electronic fob comprises a vessel having an internal volume in fluid communication with the beverage line, and a liquid level sensor configured to sense a level of a liquid within the internal volume.

30. The portable unit of claim 29, where the liquid level sensor is coupled to the electronic fob outside of the internal volume.

31. The portable unit of claim 29, where the liquid level sensor is a non-contact liquid level sensor configured to sense a level of a liquid without direct contact with the liquid.

32. The portable unit of claim 29, where the electronic fob is operable to prevent dispensing of beverage from the keg when the liquid level sensor senses a predetermined level of the liquid within the internal volume.

33. The portable unit of claim 1, where the chiller unit is operable to cool the temperature-controlled inner compartment.

34. The portable unit of claim 1, comprising an evaporator unit operable to cool the temperature-controlled inner compartment.

35. The portable unit of claim 1, comprising a radiator unit operable to cool the temperature-controlled inner compartment.

36. The portable unit of claim 1, comprising a single refrigeration unit operable to cool both the temperature-controlled inner compartment and the chiller unit.

37. The portable unit of claim 36, where the single refrigeration unit comprises an evaporator unit operable to cool the chiller unit.

38. The portable unit of claim 36, where the single refrigeration unit comprises a second evaporator unit operable to cool the temperature-controlled inner compartment.

39. The portable unit of claim 36, where the single refrigeration unit comprises a radiator unit operable to cool the temperature-controlled inner compartment.

40. The portable unit of claim 1, comprising a plurality of wheels coupled to the cabinet.
